(19) United States
(12) Patent Application Publication
(10) Pub. No.: US 2024/0401780 A1
(43) Pub. Date: Dec. 5, 2024

(54) LAMP ASSEMBLY

(71) Applicant: DONGLIN HE, Zhumadian (CN)

(72) Inventor: DONGLIN HE, Zhumadian (CN)

(21) Appl. No.: 18/203,083

(22) Filed: May 30, 2023

(51) Int. Cl. F21V 23/06; F21V 17/08; F21V 17/12

(52) U.S. Cl. CPC F21V 17/08; F21V 17/12; F21V 23/06

(57) ABSTRACT

A lamp assembly, comprising a conductive piece and a plug housing, the plug housing comprises a conductive piece installation box, and the conductive piece installation box is set in the plug housing; one end of the conductive piece set in the conductive piece installation box is arranged with one or more horizontal U-shaped resisting section; the one end of the conductive piece set in the conductive piece installation box is arranged in the conductive piece installation groove; the conductive piece installation box is arranged with a resisting part at the position of the U-shaped groove corresponding to the transverse U-shaped resisting section of the conductive piece. The electric plug improves the pulling force of the exposed conductor and the electric conductor of the electric plug, and the B conductive piece and the conductive piece installation box are not easy to be damaged, thereby improving the service life of the plug.

### TECHNICAL FIELD

The present disclosure relates to the technical filed of lighting, and in particular to a lamp assembly.

### BACKGROUND

With the universality of the use of electric plugs, the quality requirement for electric plugs is getting higher and higher. FIGS. 1 to 5 are electric plugs in the prior art, comprising a conductive piece installation box, A conductive piece and B conductive piece, as shown in FIG. 1, one end of the A conductive piece and the B conductive piece are installed in the conductive piece installation box, there is a safety slot in the conductive installation box; as shown in FIG. 2 and FIG. 3, it is a schematic structural diagram of the A conductive piece and the A conductive piece is installed on one end of the conductive piece installation box where is a bending part and an A card slot. The A card slot is stuck on the edge of the conductive piece installation box, and there is a protrusion on the end of the A conductive piece away from the conductive piece installation box; as shown in FIG. 4 and FIG. 5, on end of the B conductive piece sated in the conductive piece installation box comprises a first end portion and a second end portion, the first end portion is a straight end, the second end portion comprises a first bent portion and a second bent portion, and the second bent portion extends into the safety slot and is located on the side close to the B conductive piece. The first bending part and the second bending part of the straight end constitute a vertical U-shaped resisting section. The vertical U-shaped resisting section refers to the opening direction of U-shaped is perpendicular to the cross section of the conductive piece. With the above structure, when the plug is inserted into or pulled out of the socket, the direction of the force applied to the conductive piece installation box is different, which will cause the direction of the force of the A and B conductive pieces to be different. When the A conductive piece is stressed, it is mainly caused by the A conductive piece. The bending part and the A card slot are used as the force bearing parts. Since there is only one bending part on the A conductive piece, the force bearing area is small, so the stress condition is not good. When the B conductive piece is stressed, it is mainly due to the first bending part. As the force bearing part, the bent part has a small force bearing area, so the force bearing condition is not good. Based on the above reasons, the electric plug with this structure is easily damaged after repeated use and has a short service life.

### SUMMARY

The purpose of the present disclosure is to provide a lamp assembly, which can solve the problem mentioned in the above background.

In order to achieve the above purpose, the present disclosure provides the following technical solutions: a lamp assembly, comprising a lamp cap, a bulb and a lampshade, the lampshade is arranged under the lamp cap, and the exterior of the lamp cap is arranged with a first connection mechanism for connecting the lampshade, the bottom of the lamp cap is arranged with a lamp tube, and the inside of the lamp tube is arranged with a wick, and the inside of the lamp cap is arranged with a second connection mechanism for connecting the lamp tube, and the bulb is made up of lamp cap, lamp tube and lampshade, and there are multiple bulbs, which are connected in series between adjacent bulbs.

Wherein the first connection mechanism comprises an external thread, and the lamp cap and the lampshade are connected by the external thread.

Wherein the second connection mechanism comprises an internal thread, and the internal thread is arranged inside the lamp cap, and the lamp tube and the lamp cap are connected by the internal thread.

Wherein a first gasket for sealing is arranged between the lampshade and the lamp cap, and a second gasket for sealing is arranged between the lamp tube and the lamp cap.

A conductive piece of electric plug, comprising one end inside the plug housing and one end outside the plug housing, the one end inside the plug housing is arranged with one or more horizontal U-shaped resisting section.

Wherein the conductive piece is arranged in the slot at the edge of the plug housing.

Wherein the one end of the conductive piece inside the plug housing is arranged with one horizontal U-shaped resisting section, and the side of the horizontal U-shaped resisting section away from the outer end of the plug housing is arranged with a wire connection terminal.

Wherein the one end of the conductive piece inside the plug housing is arranged with one horizontal U-shaped resisting section, and also arranged with an abutment portion and an electrical connection portion, one end of the abutment portion is connected to the conductive piece, and the other end is connected to the electrical connection portion.

A electric plug, comprising a conductive piece and a plug housing, the plug housing comprises a conductive piece installation box, and the conductive piece installation box is set in the plug housing; the conductive piece installation box is arranged with a conductive piece installation groove; the conductive piece comprises one end set in the conductive piece installation box and another end set outside, wherein one end of the conductive piece set in the conductive piece installation box is arranged with one or more horizontal U-shaped resisting section; the one end of the conductive piece set in the conductive piece installation box is arranged in the conductive piece installation groove; the conductive piece installation box is arranged with a resisting part at the position of the U-shaped groove corresponding to the transverse U-shaped resisting section of the conductive piece.

Compared with the prior art, the beneficial effects of the present disclosure are:

The surface area of the resisting portion of the present disclosure is increased, so the restriction effect is greater, so that the installation firmness of the B conductive piece in the conductive piece installation box is improved, and the force on the B conductive piece is not only composed of two U-shaped, at the same time, the resisting part also bears part of the force. Therefore, the pulling force of the exposed conductor and the electric conductor of the electric plug is improved, and the B conductive piece and the conductive piece installation box are not easily damaged, which improves the service life of the plug.

### BRIEF DESCRIPTION OF DRAWINGS

FIG. 1 is a schematic diagram of an electric plug of prior art.

FIG. 2 is a main view diagram of A conductive piece of prior art.

FIG. 3 is a right view diagram of A conductive piece of prior art.

FIG. 4 is a main view diagram of B conductive piece of prior art.

FIG. 5 is a left view diagram of B conductive piece of prior art.

FIG. 6 is a schematic diagram of an electric plug of the present disclosure.

FIG. 7 is a main view diagram of A conductive piece of the present disclosure.

FIG. 8 is a right view diagram of A conductive piece of the present disclosure.

FIG. 9 is a main view diagram of B conductive piece of the present disclosure.

FIG. 10 is a left view diagram of B conductive piece of the present disclosure.

FIG. 11 is another main view diagram of A conductive piece of the present disclosure.

FIG. 12 is a schematic diagram of a lamp assembly of the present disclosure.

FIG. 13 is an explosion diagram of a lamp assembly of the present disclosure.

FIG. 14 is an sectional view diagram of a lamp assembly of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only part of the embodiments of the present disclosure, not all of them. Based on the embodiments of the present disclosure, all other embodiments obtained by persons of ordinary skill in the art without making creative efforts belong to the scope of protection of the present disclosure.

### Embodiment 1

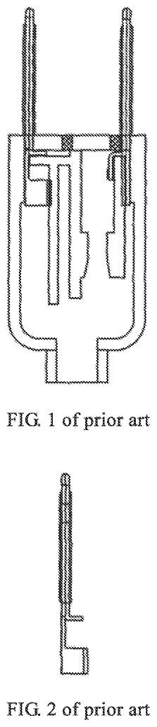

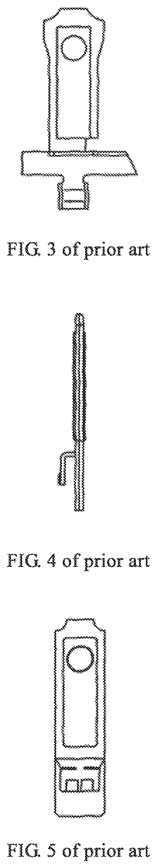

With the universality of the use of electric plugs, the quality requirement for electric plugs is getting higher and higher. FIGS. 1 to 5 are electric plugs in the prior art, comprising a conductive piece installation box, A conductive piece and B conductive piece, as shown in FIG. 1, one end of the A conductive piece and the B conductive piece are installed in the conductive piece installation box, there is a safety slot in the conductive installation box; as shown in FIG. 2 and FIG. 3, it is a schematic structural diagram of the A conductive piece and the A conductive piece is installed on one end of the conductive piece installation box where is a bending part and an A card slot. The A card slot is stuck on the edge of the conductive piece installation box, and there is a protrusion on the end of the A conductive piece away from the conductive piece installation box; as shown in FIG. 4 and FIG. 5, on end of the B conductive piece sated in the conductive piece installation box comprises a first end portion and a second end portion, the first end portion is a straight end, the second end portion comprises a first bent portion and a second bent portion, and the second bent portion extends into the safety slot and is located on the side close to the B conductive piece. The first bending part and the second bending part of the straight end constitute a vertical U-shaped resisting section. The vertical U-shaped resisting section refers to the opening direction of U-shaped is perpendicular to the cross section of the conductive piece. With the above structure, when the plug is inserted into or pulled out of the socket, the direction of the force applied to the conductive piece installation box is different, which will cause the direction of the force of the A and B conductive pieces to be different. When the A conductive piece is stressed, it is mainly caused by the A conductive piece. The bending part and the A card slot are used as the force bearing parts. Since there is only one bending part on the A conductive piece, the force bearing area is small, so the stress condition is not good. When the B conductive piece is stressed, it is mainly due to the first bending part. As the force bearing part, the bent part has a small force bearing area, so the force bearing condition is not good. Based on the above reasons, the electric plug with this structure is easily damaged after repeated use and has a short service life.

The present disclosure will be described in further detail below in conjunction with the accompanying drawings and specific embodiments.

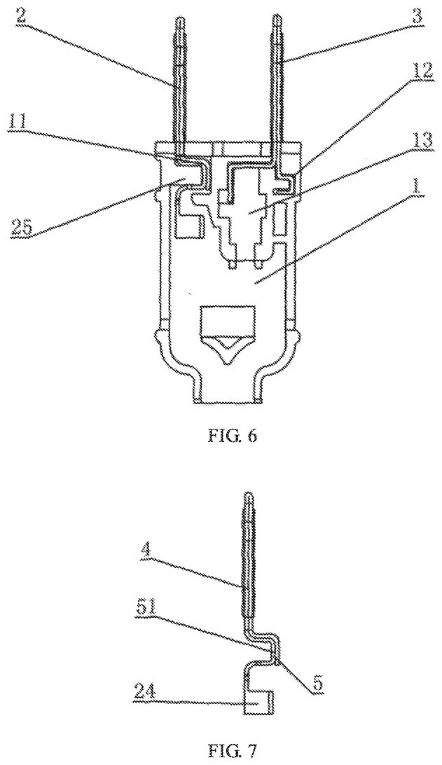

The conductive piece of electric plug shown in FIG. 7 and FIG. 8 is composed of one end 5 located in the plug housing and one end 4 located outside the plug housing, and one end 5 located in the plug housing is arranged with one or more horizontal U Shaped resisting section 51, the so-called horizontal U-shaped resisting section 51 means that the U-shaped opening direction is parallel to the cross-section of the conductive piece or does not include any other angle of 90°. In this embodiment, the quantity of the horizontal U-shaped resisting section 51 is one, and a horizontal U-shaped resisting section 51 is set, which is convenient for processing, saves materials, and has good installation firmness and good safety and reliability in use: the side of the horizontal U-shaped resisting section 51 away from the outer end 4 of the plug housing is arranged with a wire connection terminal 24, and the wire connection terminal 24 is U-shaped, so that it is convenient to connect with the wire; the conductive piece is arranged in a card slot 26 at the edge of the plug housing, and the card slot 26 is stuck on the edge of the conductive piece installation box, the conductive piece is not easy to disengage from the plug housing.

The electric plug conductive piece shown in FIG. 11 is composed of one end 5 located inside the plug housing and one end 4 located outside the plug housing, and one end 5 located inside the plug housing is arranged with one or more one horizontal U-shaped resisting section 51. The so-called horizontal U-shaped resisting section 51 means that the U-shaped opening direction is parallel to the cross-section of the conductive piece or does not include any other angle of 90°. As shown in FIG. 11, in this embodiment, the horizontal U-shaped resisting section 51 is two modified horizontal U-shaped resisting sections, and the horizontal U-shaped resisting section 51 is set, which has good installation firmness and good safety and reliability in use; the side of the horizontal U-shaped resisting section 51 away from the outer end 4 of the plug housing is arranged with a wire connection terminal 24, and wire connecting terminal 24 is U-shaped, and like this, is convenient to be connected with electric wire; the conductive piece is arranged in a card slot 26 at the edge of the plug housing, and the card slot 26 is stuck on the edge of the conductive piece installation box, the conductive piece is not easy to disengage from the plug housing.

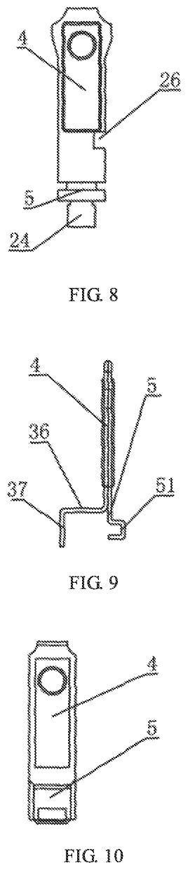

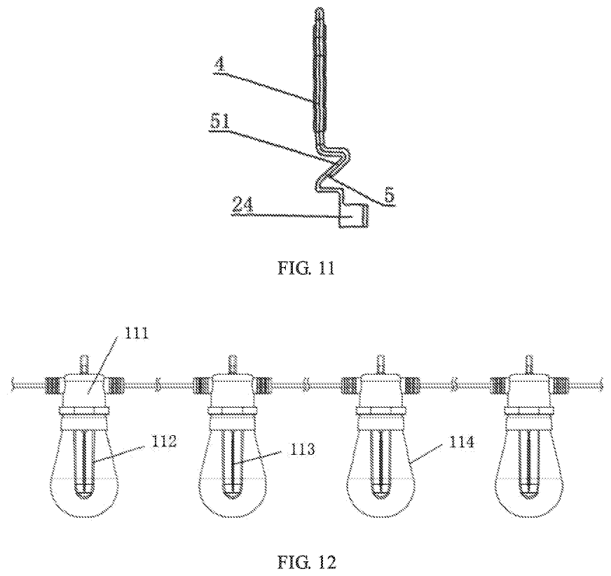

The conductive piece of electric plug shown in FIG. 9 and FIG. 10 is composed of one end 5 located in the plug housing and one end 4 located outside the plug housing, and one end 5 located in the plug housing is arranged with one or more horizontal U Shaped resisting section 51, the so-called horizontal U-shaped resisting section 51 means that the U-shaped opening direction is parallel to the cross-section of the conductive piece or does not include any other angle of 90°. In this embodiment, the quantity of the horizontal U-shaped resisting section 51 is one, and a horizontal U-shaped resisting section 51 is set, which is convenient for processing, saves materials, and has good installation firmness and good safety and reliability in use; one end of the conductive piece inside the plug housing is arranged with an abutment portion 36 and an electrical connection portion 37, one end of the abutment portion 36 is connected to the conductive piece, and the other end is connected to the electrical connection portion 37. In this way, it is convenient to electrically connect with the outside world.

The electrical plug as shown in FIGS. 6 to 10 is composed of a conductive piece installation box 1, A conductive piece 2, B conductive piece 3 and a plug shell (not shown); A conductive piece installation groove 11 and B conductive piece installation groove 12 are arranged in the conductive piece installation box 1; A safety placement groove 13 is arranged between A conductive piece installation groove 11 and B conductive piece installation groove 12; The A conductive piece 2 is arranged at one end of conductive piece installation box 1 and is arranged with one or more horizontal U-shaped resisting section 51, the so-called horizontal U-shaped resisting section 51 means that the U-shaped opening direction is parallel to the cross-section of the conductive piece or does not include any other angle of 90°. In the present disclosure, as shown in FIG. 7 As shown, there is one horizontal U-shaped resisting section 51. As shown in FIG. 11, the horizontal U-shaped resisting section 51 can also be a modified horizontal U-shaped resisting section. One end of the A conductive piece 2 located on the conductive piece installation box 1 is installed in the A conductive piece installation groove 11, as shown in FIG. 6, the U-shaped groove position corresponding to the A conductive piece horizontal U-shaped resistance section in the conductive piece installation box 1 is arranged with a resisting portion 25, like this, When the A conductive piece 2 is subjected to forces in different directions, the A conductive piece 2 installed in the A conductive piece installation groove 11 has a large stress area, and the resisting part 25 has a restrictive effect on the horizontal U-shaped resisting section. Therefore, the A conductive piece 2 is installed in the conductive piece installation box 1 with good firmness, the A conductive piece 2 is not easy to detach from the conductive piece installation box 1, and the use is safe and reliable, and when the A conductive piece 2 is stressed, it is formed by two U-shaped side walls As the force receiving part, the exposed conductor of the electric plug and the pulling force of the electric conductor are improved, the electric plug is not easy to be damaged, and the service life is improved; in order to further improve the installation reliability of the A conductive piece 2 in the conductive piece installation box 1, the A card slot 26 is opened on the conductive piece 2, and the card slot 26 is stuck on the edge of the conductive piece installation box 1.

As shown in FIGS. 9 and 10, the B conductive piece 3 is arranged with one or more horizontal U-shaped resisting section 51 on one end 5 of the conductive piece installation box 1, as shown in FIG. 9, in this embodiment, there is one horizontal U-shaped resisting section 51, and one end 5 of the B conductive piece 3 located in the conductive piece installation box 1 is installed in the B conductive piece installation groove 12, as shown in FIG. 6, in the conductive piece installation box 1 corresponding to the B The U-shaped groove position of the horizontal U-shaped resisting section of the conductive plate is arranged with a resisting portion 25; when the B conductive plate 3 is subjected to forces from different directions, the force bearing area of the B conductive plate 2 installed in the B conductive plate installation groove 12 is large, And the resisting portion 25 has a restrictive effect on the horizontal U-shaped resisting section. Therefore, the B conductive piece 3 is installed in the conductive piece installation box 1 with good firmness, and the B conductive piece 3 is not easy to detach from the conductive piece installation box 1, so it is safe and reliable to use good performance, and when the B conductive piece 3 is under force, the two U-shaped side walls are used as force bearing parts, which improves the pulling force of the exposed conductor of the electric plug and the electric conductor, the electric plug is not easy to damage, and the service life is improved. The B conductive piece 3 is located at the inner end of the conductive piece installation box 1 and is also arranged with an abutment portion 36 and an electrical connection portion 37, one end of the abutment portion 36 is connected with the B conductive piece 3, and the other end is connected with the electrical connection portion 37, The electrical connection part 37 is arranged on the side of the insurance placement groove 13 away from the B conductive piece installation groove 12, and the abutment part 36 is arranged on a side of the insurance placement groove 13 adjacent to the B conductive piece 3 where the electrical connection part 37 is set, and the abutment part 36 is set on the side of the insurance placement groove 13 adjacent to the electrical connection part 37 and close to the B conductive piece 3. After the B conductive piece 3 is installed in the conductive piece installation box 1, The side of the insurance placement groove 13 arranged with the resisting portion 36 has a restrictive effect on the resisting portion 36. Compared with the prior art, the surface area of the resisting portion 36 increases, so the restrictive effect is greater. Like this, the B conductive piece 3 is improved. The installation firmness of the conductive piece installation box 1, and the force on the B conductive piece 3 is not only borne by the two U-shaped side walls, but also part of the force is borne by the resisting part, so the electric plug is greatly improved. The pulling force of the exposed conductor and the electric conductor, and the B conductive piece 3 and the conductive piece installation box 1 are not easily damaged, which improves the service life of the plug; an electrical connection part is arranged to ensure a good electrical connection between the fuse and the B conductive piece.

### Embodiment 2

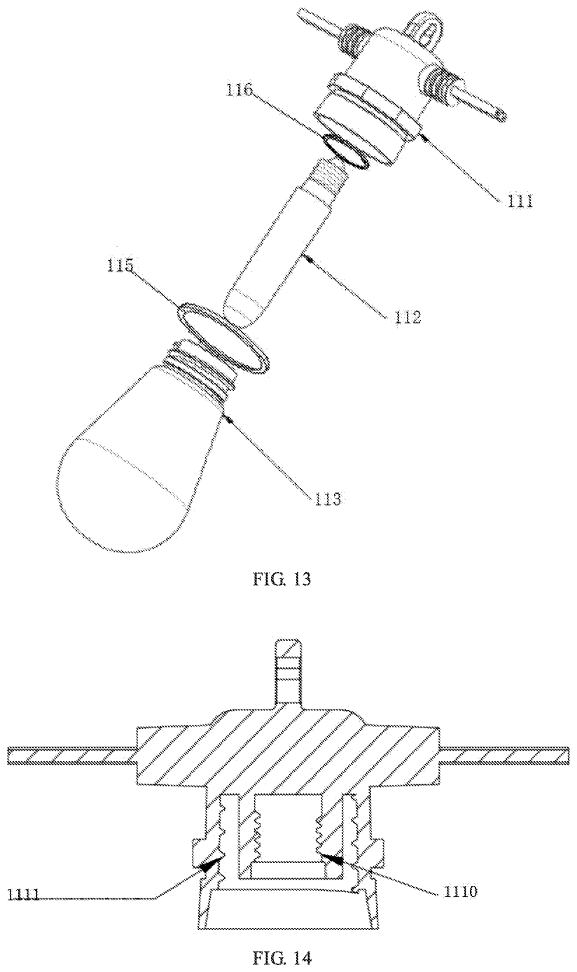

Please refer to FIGS. 12-14, the present disclosure provides the following technical solutions: A lamp assembly, comprising a lamp cap 111, a bulb and a lampshade 113, the lampshade 113 is arranged under the lamp cap 111, and the exterior of the lamp cap 111 is arranged with a first connection mechanism for connecting the lampshade 113, the bottom of the lamp cap 111 is arranged with a lamp tube 112, and the inside of the lamp tube 112 is arranged with a wick 114, and the inside of the lamp cap 111 is arranged with a second connection mechanism for connecting the lamp tube 112, and the bulb is made up of lamp cap 111, lamp tube 112 and lampshade 113, and there are multiple bulbs, which are connected in series between adjacent bulbs.

In the present disclosure, the first connection mechanism comprises an external thread (1111), and the lamp cap 111 and the lampshade 113 are connected by the external thread 1111.

In the present disclosure, the second connection mechanism comprises an internal thread 1110, and the internal thread 1110 is arranged inside the lamp cap 111, and the lamp tube 112 and the lamp cap 111 are connected by the internal thread 1110.

In the present disclosure, a first gasket 115 for sealing is arranged between the lampshade 113 and the lamp cap 111, and a second gasket 116 for sealing is arranged between the lamp tube 112 and the lamp cap 111.

The working principle of this embodiment: in actual use, because the lamp cap 111 is detachably connected to the lamp tube 112 body and the lampshade 113 that is detachably connected to the lamp cap 111, the wick 114 is designed to be a lamp tube 112 of a threaded lamp cap that is convenient for replacement, so that in the sales process, according to the different color temperature requirements of customers, it can be quickly replaced with products with color temperature that customers need, so as to meet the various needs of light strings with the same specification and different color temperatures in the market. At the same time, in terms of after-sales maintenance, professional tools are not required. Manual replacement of the threaded lamp holder lamp tube 112 saves time and effort.

It should be noted that in this article, relational terms such as first and second are only used to distinguish one entity or operation from another entity or operation, and do not necessarily require or imply that there is a relationship between these entities or operations. There is no such actual relationship or order between them. Furthermore, the term “comprise”, “include” or any other variation thereof is intended to cover a non-exclusive inclusion such that a process, method, article, or apparatus comprising a set of elements includes not only those elements, but also includes elements not expressly listed. other elements of or also include elements inherent in such a process, method, article, or device.

Although the embodiments of the present disclosure have been shown and described, those skilled in the art can understand that various changes and modifications can be made to these embodiments without departing from the principle and spirit of the present disclosure, replacements and modifications, the scope of the present disclosure is defined by the appended claims and their equivalents.

1. A lamp assembly, comprising a lamp cap, a bulb and a lampshade, the lampshade is arranged under the lamp cap, and the exterior of the lamp cap is arranged with a first connection mechanism for connecting the lampshade, the bottom of the lamp cap is arranged with a lamp tube, and the inside of the lamp tube is arranged with a wick, and the inside of the lamp cap is arranged with a second connection mechanism for connecting the lamp tube, and the bulb is made up of lamp cap, lamp tube and lampshade, and there are multiple bulbs, which are connected in series between adjacent bulbs.

2. The lamp assembly according to claim 1, wherein the first connection mechanism comprises an external thread, and the lamp cap and the lampshade are connected by the external thread.

3. The lamp assembly according to claim 2, wherein the second connection mechanism comprises an internal thread, and the internal thread is arranged inside the lamp cap, and the lamp tube and the lamp cap are connected by the internal thread.

4. The lamp assembly according to claim 3, wherein a first gasket for sealing is arranged between the lampshade and the lamp cap, and a second gasket for sealing is arranged between the lamp tube and the lamp cap.

5. A conductive piece of electric plug, comprising one end inside the plug housing and one end outside the plug housing, the one end inside the plug housing is arranged with one or more horizontal U-shaped resisting section.

6. The conductive piece of electric plug according to claim 5, wherein the conductive piece is arranged in the slot at the edge of the plug housing.

7. The conductive piece of electric plug according to claim 5, wherein the one end of the conductive piece inside the plug housing is arranged with one horizontal U-shaped resisting section, and the side of the horizontal U-shaped resisting section away from the outer end of the plug housing is arranged with a wire connection terminal.

8. The conductive piece of electric plug according to claim 6, wherein the one end of the conductive piece inside the plug housing is arranged with one horizontal U-shaped resisting section, and the side of the horizontal U-shaped resisting section away from the outer end of the plug housing is arranged with a wire connection terminal.

9. The conductive piece of electric plug according to claim 7, wherein the one end of the conductive piece inside the plug housing is arranged with one horizontal U-shaped resisting section, and also arranged with an abutment portion and an electrical connection portion, one end of the abutment portion is connected to the conductive piece, and the other end is connected to the electrical connection portion.

10. A electric plug, comprising a conductive piece and a plug housing, the plug housing comprises a conductive piece installation box, and the conductive piece installation box is set in the plug housing; the conductive piece installation box is arranged with a conductive piece installation groove; the conductive piece comprises one end set in the conductive piece installation box and another end set outside, wherein one end of the conductive piece set in the conductive piece installation box is arranged with one or more horizontal U-shaped resisting section; the one end of the conductive piece set in the conductive piece installation box is arranged in the conductive piece installation groove; the conductive piece installation box is arranged with a resisting part at the position of the U-shaped groove corresponding to the transverse U-shaped resisting section of the conductive piece.
